(19) United States
(12) Patent Application Publication
(10) Pub. No.: US 2025/0270921 A1
(43) Pub. Date: Aug. 28, 2025

(54) METHOD AND SYSTEM FOR DETERMINING WELLBORE BREAKDOWN PRESSURES FOR HYDRAULIC STIMULATION OPERATIONS

(71) Applicant: ARAMCO SERVICES COMPANY, Houston, TX (US)

(72) Inventor: Yanhui Han, Houston, TX (US)

(73) Assignee: ARAMCO SERVICES COMPANY, Houston, TX (US)

(21) Appl. No.: 18/589,659

(22) Filed: Feb. 28, 2024

(51) Int. Cl. E21B 47/06; E21B 25/00; E21B 49/00

(52) U.S. Cl. CPC E21B 47/06; E21B 25/00; E21B 49/006; E21B 2200/20

(57) ABSTRACT

A method may include performing, by a drilling system, a drilling operation to produce a wellbore in a geological region of interest. The method may further include determining time elapse data describing an amount of time between the drilling operation and a hydraulic stimulation operation. The method may further include determining borehole stress data based on the wellbore, reservoir data, and geological data. The method may further include determining thermal diffusivity data regarding a temperature front in the geological region of interest based on the time elapse data, the reservoir data, and the geological data. The method may further include determining a wellbore breakdown pressure of the geological region of interest based on the thermal diffusivity data, the geological data, the borehole stress data, and the reservoir data. The method may further include transmitting a command to a stimulation control system based on the wellbore breakdown pressure.

### BACKGROUND

Oil and gas deposits may percolate up through subsurface pathways towards the Earth's surface over time by natural buoyancy. However, because of geological barriers above the oil and gas deposits which prevent oil and gas from migrating to the surface, various hydrocarbon deposits remain trapped underground. Where the porous rock is highly permeable, this hydrocarbon accumulation is commonly referred to as a conventional reservoir. As such, the oil and gas can be produced by drilling a well into a conventional reservoir. the hydrocarbons will be driven by reservoir pressure into the well then lifted to the surface. In contrast, in unconventional reservoirs where the permeability is too low to produce economically, reservoir stimulations, such as hydraulic fracturing, will be required to enhance the productivity so that hydrocarbons can be extracted economically. Breakdown pressure is a critical parameter in hydraulic fracturing stimulation design.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method that includes obtaining reservoir data for a geological region of interest. The method further includes obtaining geological data regarding a formation in the geological region of interest. The method further includes performing, by a drilling system that includes a drill bit and a drill string, a drilling operation to produce a wellbore in the geological region of interest. The method further includes determining, by a computer processor, time elapse data describing an amount of time between the drilling operation and a hydraulic stimulation operation. The method further includes determining, by the computer processor, borehole stress data based on the wellbore, the reservoir data, and the geological data. The method further includes determining, by the computer processor, thermal diffusivity data regarding a temperature front in the geological region of interest based on the time elapse data, the reservoir data, and the geological data. The method further includes determining, by the computer processor, a wellbore breakdown pressure of the geological region of interest based on the thermal diffusivity data, the geological data, the borehole stress data, and the reservoir data. The method further includes transmitting, by the computer processor, a command to a stimulation control system based on the wellbore breakdown pressure. The stimulation control system performs a hydraulic stimulation operation at the wellbore based on the wellbore breakdown pressure and in response to the command.

In general, in one aspect, embodiments relate to a system that includes a drilling system that includes a drill bit and a drill string. The system further includes a stimulation control system and a reservoir simulator coupled to the stimulation control system. The reservoir simulator includes a computer processor. The drilling system performs a drilling operation to produce a wellbore in a geological region of interest. The reservoir simulator obtains reservoir data for the geological region of interest. The reservoir simulator further obtains geological data regarding a formation in the geological region of interest. The reservoir simulator further determines time elapse data describing an amount of time between the drilling operation and a hydraulic stimulation operation. The reservoir simulator further determines borehole stress data based on the wellbore, the reservoir data, and the geological data. The reservoir simulator further determines thermal diffusivity data regarding a temperature front in the geological region of interest based on the time elapse data, the reservoir data, and the geological data. The reservoir simulator further determines a wellbore breakdown pressure of the geological region of interest based on the thermal diffusivity data, the geological data, the borehole stress data, and the reservoir data. The stimulation control system performs a hydraulic stimulation operation at the wellbore based on the wellbore breakdown pressure.

In some embodiments, a change in pressure is determined in a geological region of interest based on one or more temperature fronts diffusing throughout the geological region of interest based on an amount of time between a drilling operation and a hydraulic stimulation operation. A wellbore breakdown pressure may be based on the change in pressure. In some embodiments, wellbore data are obtained regarding a wellbore. The wellbore data may include a wellbore radius of the wellbore, inclination angle data of the wellbore, and an azimuth of the wellbore. A vertical stress on the wellbore, a maximum horizontal stress on the wellbore, and a minimum horizontal stress on the wellbore may be determined using the wellbore data and reservoir data. Various stress components of the wellbore may be determined based on the inclination angle data, various borehole coordinates, the vertical stress, the maximum horizontal stress, and the minimum horizontal stress. Confining stress data for the wellbore may be determined based on the stress components. The borehole stress data may include the confining stress data.

In some embodiments, wellbore data include vertical stress data on a wellbore, minimum horizontal stress data on the wellbore, and maximum horizontal stress data on the wellbore. In some embodiments, reservoir data include reservoir pore pressure data and reservoir temperature data. In some embodiments, geological data include formation density data, Young's modulus data, Poisson's ratio data, thermal conductivity data, specific heat data, and thermal expansion coefficient data. In some embodiments, time elapse data is obtained for a drilling operation and a hydraulic stimulation operation. A determination may be made whether a geological region of interest is disposed in a thermal steady state based on the time elapse data. The geological region of interest may surround a wellbore that is drilled by the drilling operation. A determination may be made, in response to determining that the geological region of interest is in the thermal steady state, of a wellbore breakdown pressure. The wellbore breakdown pressure may be time independent.

In some embodiments, permeability data is obtained regarding a geological region of interest. A determination may be made whether the permeability data satisfies a predetermined permeability threshold. A wellbore breakdown pressure may be based on the permeability data satisfying the predetermined permeability threshold. In some embodiments, permeability data may be obtained regarding a geological region of interest. A determination may be made whether the permeability data satisfies a predetermined permeability threshold. A wellbore breakdown pressure may be based on the permeability data satisfying the predetermined permeability threshold. In some embodiments, a drilling operation is performed at a wellbore in a geological region of interest. The drilling operation may acquire various cuttings from drilling fluid circulated in the wellbore during the drilling operation. Cutting data may be determined from the cuttings. A portion of geological data may be based on the cutting data.

In some embodiments, a core sample is acquired using a coring system that includes a coring tool from a wellbore in a geological region of interest. Core sample data may be determined using the core sample. A portion of geological data may be based on the core sample data. In some embodiments, temperature data is acquired for a geological region of interest using various downhole temperature sensors disposed in a wellbore. Pressure data may be acquired for the geological region of interest using various downhole pressure sensors disposed in the wellbore. Reservoir data may include the temperature data and the pressure data. In some embodiments, a hydraulic stimulation operation sends a hydraulic fracturing fluid into a wellbore at a predetermined flow rate using a pump system. The hydraulic fracturing fluid may include at least one propping agent. The hydraulic fracturing fluid may produce a fracture network laterally from the wellbore. In some embodiments, a user device is coupled to a stimulation control system. The user device may provide a graphical user interface for presenting a various wellbore breakdown pressures. A wellbore breakdown pressure may be selected among the wellbore breakdown pressures in the graphical user interface.

In light of the structure and functions described above, embodiments disclosed herein may include respective means adapted to carry out various steps and functions defined above in accordance with one or more aspects and any one of the embodiments of one or more aspect described herein.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1, 2A, 2B, and 3 show systems in accordance with one or more embodiments.

FIG. 4 shows a flowchart in accordance with one or more embodiments.

FIGS. 5, 6A, 6B, and 7 shows examples in accordance with one or more embodiments.

FIG. 8 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for determining one or more time-dependent breakdown pressures for inducing one or more hydraulic fractures based on modeling temperature around a wellbore. Using analytical modeling of temperature fronts, for example, a reservoir simulator may perform fast calculations for determining a thermal response within one or more geological regions following a drilling operation (e.g., the drilling operation that produces a wellbore connected to a desired hydraulicly-induced fracture). Depending on an amount of elapsed time between drilling and a planned hydraulic stimulation operation, for example, different wellbore breakdown pressures may be applied downhole to initiate fractures. If the amount of elapsed time between drilling a wellbore and performing a hydraulic stimulation operation achieves a thermal steady state, one particular wellbore breakdown pressure may be used for a specific hydraulic fracturing fluid in a selected geological region. On the other hand, if the elapsed time results in a different thermal response (e.g., non-steady state thermal response), the wellbore breakdown pressure may be adjusted to account for incremental changes in stress throughout a particular reservoir region. In addition to using elapsed time, a reservoir simulator may also use other data sources, such as in-situ conditions (e.g., various stresses occurring in a reservoir region, pore pressures, and reservoir temperature), formation properties (e.g., density, Young's modulus, Poisson's ratio, thermal conductivity, specific heat values, and thermal expansion coefficients), and/or wellbore conditions (e.g., wellbore radius, inclination angle, azimuth, wellbore fluid pressure, and wellbore temperature) to determine thermal diffusion in one or more geological regions adjacent to the wellbore (e.g., a predetermined distance from a wellbore's wall).

Furthermore, wellbore breakdown pressure (also called “fracture initiation pressure”) may refer to the pressure at which the high-pressure water (or another hydraulic fracturing fluid) is injected into a wellbore to induce one or more hydraulic fractures. In designing a hydraulic stimulation operation, a specific wellbore breakdown pressure may be used for determining a particular pumping schedule and optimization of one or more stimulation tasks. In high-temperature sandstone formations, for example, differences between injection fluid temperature and formation temperature may result in a cooling of surrounding rock mass (e.g., the injection fluid's temperature may be applied at a much lower temperature than the formation's temperature). This cooling process may significantly reduce the stress concentration around the wellbore, thereby affecting the required wellbore breakdown pressure to achieve a desired hydraulic fracture. Since the cooling process is a time-dependent process, the magnitude of stress change from this thermal response may also be time-dependent. Consequently, the wellbore breakdown pressure also becomes time-dependent between drilling a wellbore and performing the hydraulic stimulation operation. However, once the elapsed lapse time moves this transient thermal response to a thermal steady state regime, wellbore breakdown pressure may become time independent after sufficient elapsed time.

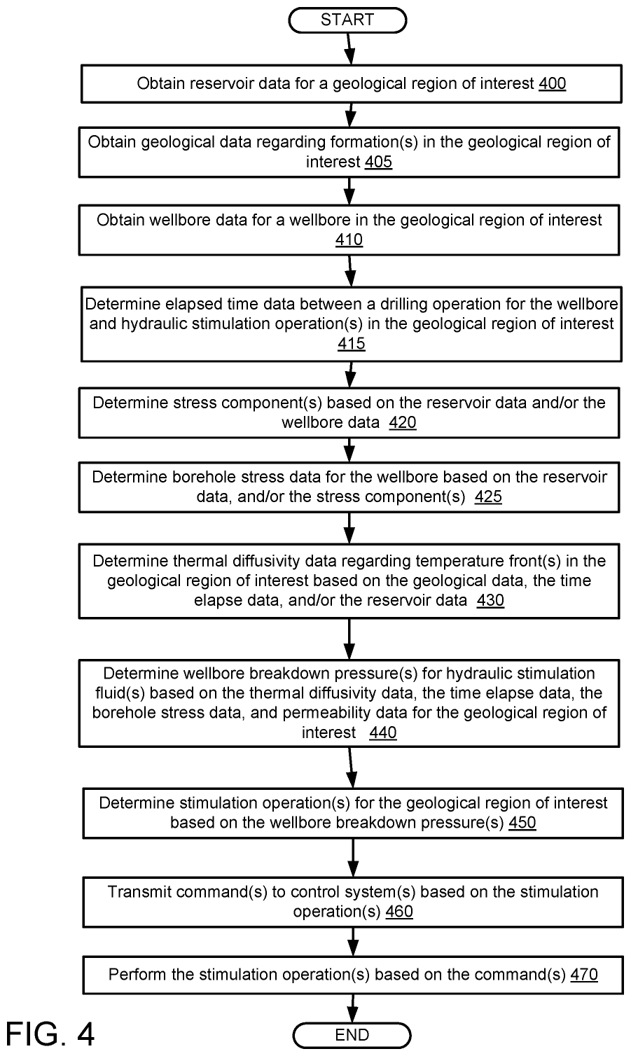

For illustration, an example conceptual model of a well injection in high-temperature formations is shown in FIG. 5. In FIG. 5, a hydraulic fracturing fluid is injected into a well located in a high-temperature high-permeability formations (e.g., a sandstone formation). In this example, the fluid temperature Tw inside a wellbore is significantly lower than the formation temperature To surrounding the wellbore. This temperature difference may result in thermal diffusion around the well, thereby cooling the surrounding rock mass. This thermal cooling may generate negative thermal stress, which can cause stress redistribution throughout one or more geological regions in a reservoir. In addition to thermal diffusion, pressure difference, i.e., the fluid pressure p_{w} in the well may also differ from formation pore pressure, p₀ surrounding the wellbore, may result in an unbalanced well condition and subsequent pore pressure diffusion.

Moreover, pore pressure diffusion and thermal diffusion processes in the formation surrounding a well may be described using hydraulic and thermal diffusion functions, respectively. Pore pressure diffusion may be expressed using the following equation:

$$\frac{\partial p}{\partial t} = {c}_{P} {∇}^{2} p \qquad Equation 1$$

where p is a formation pore pressure surrounding a wellbore and c_{P} is the coefficient of pore pressure diffusion or hydraulic diffusion of the formation. Additionally, thermal diffusion may be expressed using the following equation:

$$\frac{\partial T}{\partial t} = {c}_{T} {∇}^{2} T \qquad Equation 2$$

and T is the formation temperature surrounding the wellbore and c_{T} is the coefficient of thermal diffusion of the formation. The coefficient of hydraulic diffusion c_{P} and the coefficient of thermal diffusion c_{T} may be determined used the following equations:

$${c}_{P} = \frac{2 k G ( 1 - v ) ( {v}_{u} - v )}{{{α}^{2} ( 1 - 2 v )}^{2} ( 1 - {v}_{u} )} \qquad Equation 3$$

$${c}_{T} = \frac{{k}_{T}}{ρ {C}_{V}} \qquad Equation 4$$

where ρ is the formation's density, G is the shear modulus for the formation; k is the formation's permeability, v is Poisson's ratio for the formation, vᵤ is the undrained Poisson's ratio for the formation, α is the Biot's coefficient of effective stress, k_{T} is the thermal conductivity of the formation, and C_{V} is the specific heat of the formation. The coefficient of hydraulic diffusion c_{P} may characterize the propagation and dissipation speed of pore pressure in the formation, such as resulting from the drilling operation that produces a wellbore or other well operation. Similarly, the coefficient of thermal diffusion c_{T} may characterize the propagation speed of a temperature front in the formation.

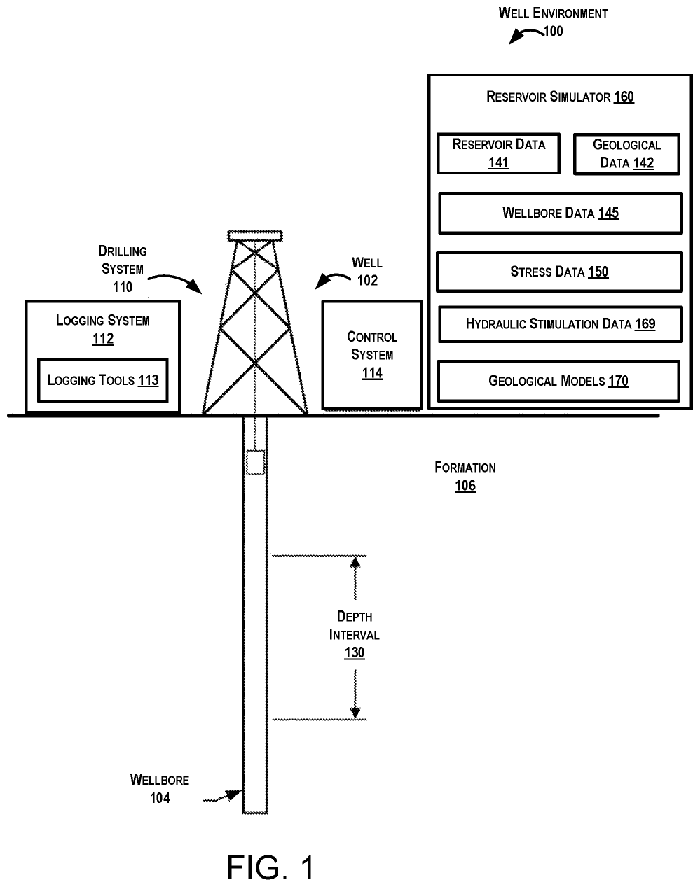

Turning to FIG. 1, FIG. 1 shows a schematic diagram in accordance with one or more embodiments. As shown, FIG. 1 illustrates a well environment (100) that may include a well (102) having a wellbore (104) extending into a formation (106). The wellbore (104) may include a bored hole that extends from the surface into a target zone of the formation (106), such as a reservoir. The formation (106) may include various formation characteristics of interest, such as formation porosity, formation permeability, resistivity, density, water saturation, and the like. Porosity may indicate how much space exists in a particular rock within a volume of interest in the formation (106), where oil, gas, and/or water may be trapped. Permeability may indicate the ability of liquids and gases to flow through the rock within the volume of interest. Resistivity may indicate how strongly rock and/or fluid within the formation (106) opposes the flow of electrical current. For example, resistivity may be indicative of the porosity of the formation (106) and the presence of hydrocarbons. More specifically, resistivity may be relatively low for a formation that has high porosity and a large amount of water, and resistivity may be relatively high for a formation that has low porosity or includes a large amount of hydrocarbons. Effective porosity may refer to that portion of the total void space of a porous material that is capable of transmitting a fluid. Effective permeability may refer to a state effective permeability as a function of a rock's absolute permeability. Water saturation may indicate the fraction of water in a given pore space.

Keeping with FIG. 1, the well environment (100) may include a reservoir simulator (160) and various well systems, such as a drilling system (110), a logging system (112), a control system (114), and a well completion system (not shown). The drilling system (110) may include a drill string, drill bit, a mud circulation system and/or the like for use in boring the wellbore (104) into the formation (106). The control system (114) may include hardware and/or software for managing drilling operations and/or maintenance operations. For example, the control system (114) may include one or more programmable logic controllers (PLCs) that include hardware and/or software with functionality to control one or more processes performed by the drilling system (110). Specifically, a programmable logic controller may control valve states, fluid levels, pipe pressures, warning alarms, and/or pressure releases throughout a drilling rig. In particular, a programmable logic controller may be a ruggedized computer system with functionality to withstand vibrations, extreme temperatures, wet conditions, and/or dusty conditions, for example, around a drilling rig. Without loss of generality, the term “control system” may refer to a drilling operation control system that is used to operate and control the equipment, a data acquisition and monitoring system that is used to acquire equipment data and to monitor one or more well operations, or a well interpretation software system that is used to analyze and understand well events, such as drilling progress. A logging system may be similar to a control system with a specific focus on managing one or more logging tools.

Turning to the reservoir simulator (160), a reservoir simulator (160) may include hardware and/or software with functionality for storing and analyzing well log data, such as borehole image data, cutting data from drilling cuttings acquired from drilling fluid circulating in a wellbore, hydraulic fracturing data, core sample data, seismic data, stress data (150), geological data (142), hydraulic stimulation data (169), wellbore data (145), reservoir data (141), such as porosity data and permeability data, and/or other types of data to generate and/or update one or more geological models (170) and/or one or more fracture models, such as models for an unconventional reservoir. Reservoir data may describe various properties of a reservoir region, such as dynamic properties adjacent to a well (e.g., pore pressure, formation temperature, porosity, permeability, etc.). Geological data may describe various geological properties of one or more formations, such as rock type, Poisson's ratio, density, Young's modulus, and thermal conductivity). Stress data may describe various stresses exerting on a wellbore and/or within a geological region, such as stress components relating to vertical and horizontal stresses or principal confining stresses, as well as changes in stress relating to hydraulic diffusion or thermal diffusion. Wellbore data may describe dynamic properties of the wellbore, such as well fluid temperature and well pressure, as well as various static well properties such as well radius, well depth, well geometry of a well path, and angle of inclination of a portion of the well path. Geological models may include geochemical or geomechanical models that describe structural relationships within a particular geological region. Cutting data may describe an analysis or rock typing performed on drill cuttings from a drilling operation, such as using visual methods of describing rock and pore characteristics. Hydraulic stimulation data may describe parameters of one or more hydraulic fracturing operations (e.g., wellbore breakdown pressures and planned fracture geometry of a geological region) and associated acquired data, such as measurements relating to any induced fractures and any related results. These different data types may be acquired during exploration, reservoir characterization, hydraulic fracturing, and production operations.

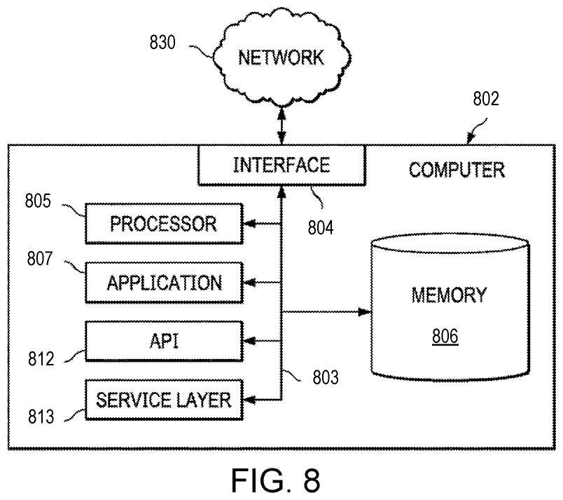

While the reservoir simulator (160) is shown at a well site, in some embodiments, the reservoir simulator (160) may be remote from a well site. In some embodiments, the reservoir simulator (160) is implemented as part of a software platform for the control system (114). The software platform may obtain data acquired by the drilling system (110) and logging system (112) as inputs, which may include multiple data types from multiple sources. The software platform may aggregate the data from these systems (110, 112) in real time for rapid analysis. In some embodiments, the control system (114), the logging system (112), the reservoir simulator (160), and/or a user device coupled to one of these systems may include a computer system that is similar to the computer system (802) described below with regard to FIG. 8 and the accompanying description.

The logging system (112) may include one or more logging tools (113) for use in generating well logs of the formation (106). For example, a logging tool may be lowered into the wellbore (104) to acquire measurements as the tool traverses a depth interval (130) (e.g., a targeted reservoir section) of the wellbore (104). The plot of the logging measurements versus depth may be referred to as a “log” or “well log”. Well log data may provide depth measurements of the wellbore (104) that describe such reservoir characteristics as formation porosity, formation permeability, resistivity, water saturation, and the like. The resulting logging measurements may be stored and/or processed, for example, by the control system (114), to generate corresponding well logs for the well (102). A well log may include, for example, a plot of a logging response time versus true vertical depth (TVD) across the depth interval (130) of the wellbore (104).

Turning to examples of logging techniques, multiple types of logging techniques are available for determining various reservoir characteristics. In some embodiments, gamma ray logging is used to measure naturally occurring gamma radiation to characterize rock or sediment regions within a wellbore. In particular, different types of rock may emit different amounts and different spectra of natural gamma radiation. For example, gamma ray logs may distinguish between shales and sandstones/carbonate rocks because radioactive potassium may be common to shales. Likewise, the cation exchange capacity of clay within shales may also result in higher absorption of uranium and thorium further increasing the amount of gamma radiation produced by shales.

Turning to nuclear magnetic resonance (NMR) logging, an NMR logging tool may measure the induced magnetic moment of hydrogen nuclei (i.e., protons) contained within the fluid-filled pore space of porous media (e.g., reservoir rocks). Thus, NMR logs may measure the magnetic response of fluids present in the pore spaces of the reservoir rocks. In so doing, NMR logs may measure both porosity and permeability, as well as the types of fluids present in the pore spaces. Thus, NMR logging may be a subcategory of electromagnetic logging that responds to the presence of hydrogen protons rather than a rock matrix. Because hydrogen protons may occur primarily in pore fluids, NMR logging may directly or indirectly measure the volume, composition, viscosity, and distribution of pore fluids.

Turning to spontaneous potential (SP) logging, SP logging may determine the permeabilities of rocks in the formation (106) by measuring the amount of electrical current generated between drilling fluid produced by the drilling system (110) and formation water that is held in pore spaces of the reservoir rock. Porous sandstones with high permeabilities may generate more electricity than impermeable shales. Thus, SP logs may be used to identify sandstones from shales.

Another type of electrical logging technique is resistivity logging. Resistivity logging may measure the electrical resistivity of rock or sediment in and around the wellbore (104). In particular, resistivity measurements may determine what types of fluids are present in the formation (106) by measuring how effective these rocks are at conducting electricity. Because fresh water and oil are poor conductors of electricity, they have high resistivities. As such, resistivity measurements obtained via such logging can be used to determine corresponding reservoir water saturation (S_{w}).

Another electrical logging technique is dielectric logging. For example, dielectric permittivity may be defined as a physical quantity that describes the propagation of an electromagnetic field through a dielectric medium. As such, dielectric permittivity may describe a physical medium's ability to polarize in response to an electromagnetic field, and thus reduce the total electric field inside the physical medium. In a portion of reservoir rock, water may have a large dielectric permittivity that is higher than any associated rock or hydrocarbon fluids within the portion. In particular, water permittivity may depend on a frequency of an electromagnetic wave, water pressure, water temperature, and salinity of the reservoir rock mixture. Likewise, a multi-frequency dielectric logging tool may determine a value of the water-filled porosity in the reservoir rock.

Keeping with dielectric logging, a dielectric logging tool may determine a dielectric constant (i.e., relative-permittivity) measurement. For example, the dielectric logging tool may include an antenna that detects relative dielectric constants between different fluids at a fluid interface. As such, a dielectric logging tool may generate a dielectric log of the high-frequency dielectric properties of a formation. In particular, a dielectric log may include two curves, where one curve may describe the relative dielectric permittivity of the analyzed rock and the other curve may describe the resistivity of the analyzed rock. Relative dielectric permittivity may be used to distinguish hydrocarbons from water of differing salinities. However, the effect of salinity may be more important than the salinity effect with a high-frequency dielectric log (also called an “electromagnetic propagation log”).

Turning to sonic logging or acoustic logging, the logging system (112) may measure the speed that acoustic waves travel through rocks in the formation (106) to determine porosity in the formation (106). This type of logging may generate borehole compensated (BHC) logs, which are also called sonic logs. In general, sound waves may travel faster through high-density shales than through lower-density sandstones. Other types of logging include density logging and neutron logging. Density logging may determine porosity measurements by directly measuring the density of the rocks in the formation (106). Furthermore, neutron logging may determine porosity measurements by assuming that the reservoir pore spaces within the formation (106) are filled with either water or oil and then measuring the amount of hydrogen atoms (i.e., neutrons) in the pores.

Turning to coring, reservoir characteristics may be determined using core sample data acquired from a well site. For example, certain reservoir characteristics can be determined via coring (e.g., physical extraction of rock specimens) to produce core specimens and/or logging operations (e.g., wireline logging, logging-while-drilling (LWD) and measurement-while-drilling (MWD)). Coring operations may include physically extracting a rock specimen from a region of interest within the wellbore (104) for detailed laboratory analysis. For example, when drilling an oil or gas well, a coring bit may cut core plugs (or “cores” or “core specimens”) from the formation (106) and bring the core plugs to the surface, and these core specimens may be analyzed at the surface (e.g., in a lab) to determine various characteristics of the formation (106) at the location where the specimen was obtained.

Turning to various coring technique examples, conventional coring may include collecting a cylindrical specimen of rock from the wellbore (104) using a core bit, a core barrel, and a core catcher. The core bit may have a hole in its center that allows the core bit to drill around a central cylinder of rock. Subsequently, the resulting core specimen may be acquired by the core bit and disposed inside the core barrel. More specifically, the core barrel may include a special storage chamber within a coring tool for holding the core specimen. Furthermore, the core catcher may provide a grip to the bottom of a core and, as tension is applied to the drill string, the rock under the core breaks away from the undrilled formation below coring tool. Thus, the core catcher may retain the core specimen to avoid the core specimen falling through the bottom of the drill string. In some embodiments, a micro computed tomography (micro-CT) scan is performed on a core sample. Several types of micro-CT scanning may be used, such as a desktop micro-CT scanner that uses an X-ray generation tube, and a synchrotron X-ray micro-tomography. In particular, a micro-CT scanner may use various X-rays to penetrate from different viewpoints in a core sample to produce an attenuated projection profile that is used for later reconstruction using a filtered back projection algorithm.

In some embodiments, cutting samples are acquired and analyzed from one or more drilling operations to determine various geological properties of one or more formations. In particular, cuttings may be initially cleaned in liquid detergent to remove drilling additives and before being dried on a ‘hotplate’. Dried cutting samples may be passed through one or more sieves to remove fragments of various sizes. Likewise, a magnet may be placed over a sieved cutting sample to remove any metallic fragments acquired during a drilling operation. After selecting various desired samples from the sieving and other preparation processes, selected samples may be ground into a fine powder for analysis using X-ray fluorescence (XRF) spectrometry processing and/or and inductively coupled plasma (ICP) spectrometry processing.

In some embodiments, various downhole sensors are used to obtain reservoir data regarding one or more geological regions. In some embodiments, downhole pressure sensors include absolute pressure transmitters, differential-pressure transmitters, and/or multivariable transmitters. Absolute pressure transmitters may include sensors that measure pressure with respect to a full vacuum, while differential-pressure transmitters may include sensors that are used in flow applications. Multivariable transmitters may measure pressure in addition to other variables, such as temperature. For example, a multivariable transmitter may be a gauge sensor that measures both pressure and temperature at a single point, such as a single quartz crystal. Multivariable transmitters may be transmit-only devices in a well providing pressure and temperature (PT) measurements at fixed time intervals, e.g., using one or more electric lines and one or more hydraulic lines. Likewise, multivariable transmitters may transmit pressure and temperature data to a well surface using a high-speed digital telemetry link. Similar to downhole pressure sensors, downhole temperature sensors may include downhole temperature gauges, temperature transmitters, and/or multivariable transmitters. In some embodiments, permanent downhole gauges (PDGs) are used that are permanently installed in a well and used to detect pressure data and/or temperature data.

In some embodiments, downhole samples are used to determine pressure-volume-temperature (PVT) properties of one or more regions in an unconventional reservoir. In particular, a PVT laboratory test on a downhole fluid sample may use multiple stages. For example, separator test experiments may be carried out for both oil and gas condensate mixtures. A sample of reservoir fluid may be placed in a laboratory cell and brought to reservoir temperature and bubble-point pressure. Afterwards, fluid may be expelled from the laboratory cell through a number of stages of separation. Usually, two or three stages of separation are used, with the last stage at atmospheric pressure and near-ambient temperature.

Keeping with PVT data, PVT properties may be used for hydrocarbon reserve estimations, reservoir modeling, production and pressure analysis, and for predicting well production performance. Thus, PVT properties may be identified by relating specific properties of unconventional reservoir fluids with various reservoir measurements, such as saturation pressure and oil formation volume factor may be correlated with reservoir temperature, stock tank oil gravity, specific gas gravity, and/or solution gas-oil-ratios. More specifically, PVT may be determined using various PVT correlation methods, such as non-parametric correlation methods that provide a multivariate optimization without using a specific model. Examples of PVT correlation methods may include exponential-polynomial functions and rational polynomial functions. In addition to PVT correlation methods, PVT properties may be further determined using equation-of-state (EOS). Equations-of-state may be computationally complex, thereby requiring detailed compositions of reservoir fluids. An example of EOS is a mathematical function that relates pressure, molar volume, temperature, and composition for modelling a fluid system (e.g., a reservoir region).

In some embodiments, a user device may communicate with a well manager to adjust dynamically stimulation parameters for a stimulation operation based on one or more user selections. The well manager may be a controller implemented in a computer network and/or one or more control system disposed in a well environment. The user device may be a personal computer, a handheld computer device such as a smartphone or personal digital assistant, or a human machine interface (HMI). For example, a user may interact with a graphical user interface to change one or more induced pressures for hydraulic stimulation fluid for use in a fracturing operation. Through user selections or automation, a well manager may provide information in a hydraulic stimulation in a graphical user interface. As such, a well manager may provide agility and flexibility in determining and modifying hydraulic stimulation operations.

Keeping with FIG. 1, geosteering may be used to position the drill bit or drill string of the drilling system (110) relative to a boundary between different subsurface layers (e.g., overlying, underlying, and lateral layers of a pay zone) during drilling operations. In particular, geological model may be used by the drilling system (110) for steering the drill bit in the direction of desired hydrocarbon concentrations. In some embodiments, a well path of a wellbore (104) may be updated by the control system (114) using a geological model. For example, a control system (114) may communicate geosteering commands to the drilling system (110) based on well log data updates or predicted hydrocarbon data that are further adjusted by the reservoir simulator (160) using a geological model. As such, the control system (114) may generate one or more control signals for drilling equipment (or a logging system may generate for logging equipment) based on an updated well path design and/or an updated geological model. As such, a geosteering system may use various sensors located inside or adjacent to the drill string to determine different rock formations within a well path. In some geosteering systems, drilling tools may use resistivity or acoustic measurements to guide the drill bit during horizontal or lateral drilling.

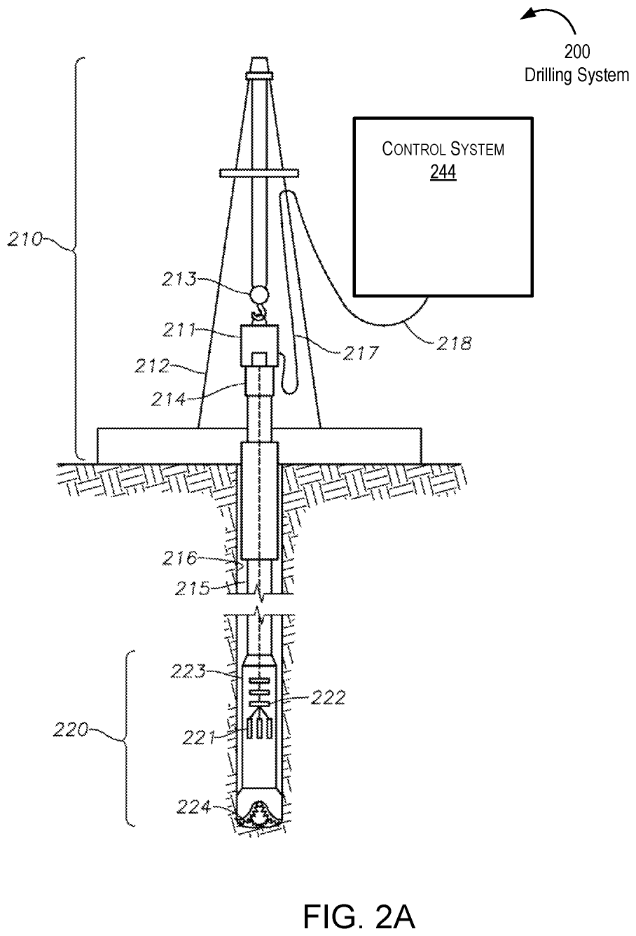

Turning to FIGS. 2A and 2B, FIG. 2A illustrates a system in accordance with one or more embodiments. As shown in FIG. 2A, a drilling system (200) may include a top drive drill rig (210) arranged around the setup of a drill bit logging tool (220). A top drive drill rig (210) may include a top drive (211) that may be suspended in a derrick (212) by a travelling block (213). In the center of the top drive (211), a drive shaft (214) may be coupled to a top pipe of a drill string (215), for example, by threads. The top drive (211) may rotate the drive shaft (214), so that the drill string (215) and a drill bit logging tool (220) cut the rock at the bottom of a wellbore (216). A power cable (217) supplying electric power to the top drive (211) may be protected inside one or more service loops (218) coupled to a control system (244). As such, drilling fluid may be pumped into the wellbore (216) using the drive shaft (214) and/or the drill string (215). Likewise, the drilling system may also include a mud pump, a mud line, mud pits, a mud return, and other components related to the circulation or recirculation of drilling fluid within the wellbore (216). The control system (244) may be similar to various control systems described above in FIG. 1 and the accompanying description.

In some embodiments, the drilling system (200) includes a bottomhole assembly (BHA). The bottomhole assembly may refer to a lower portion of the drill string (215) that includes a drill bit (224), bit sub (i.e., a substitute adapter), and a drill collar. The bottomhole assembly may also include a mud motor, stabilizers, heavy-weight drillpipe, jarring devices (“jars”), crossovers for various threadforms, directional drilling and measuring equipment, measurements-while-drilling tools, logging-while-drilling tools, and other specialized devices. The bottomhole assembly may produce force for the drill bit to break rock and provide the drilling system with directional control of a wellbore. Different types of bottomhole assemblies may be used, such as a rotary assembly, a fulcrum assembly, and a pendulum assembly.

Moreover, when completing a well, casing may be inserted into the wellbore (216). The sides of the wellbore (216) may require support, and thus the casing may be used for supporting the sides of the wellbore (216). As such, a space between the casing and the untreated sides of the wellbore (216) may be cemented to hold the casing in place. The cement may be forced through a lower end of the casing and into an annulus between the casing and a wall of the wellbore (216). More specifically, a cementing plug may be used for pushing the cement from the casing. For example, the cementing plug may be a rubber plug used to separate cement slurry from other fluids, reducing contamination and maintaining predictable slurry performance. A displacement fluid, such as water, or an appropriately weighted drilling fluid, may be pumped into the casing above the cementing plug. This displacement fluid may be pressurized fluid that serves to urge the cementing plug downward through the casing to extrude the cement from the casing outlet and back up into the annulus.

As further shown in FIG. 2A, sensors (221) may be included in a sensor assembly (223), which is positioned adjacent to a drill bit (224) and coupled to the drill string (215). Sensors (221) may also be coupled to a processor assembly that includes a processor, memory, and an analog-to-digital converter (222) for processing sensor measurements. For example, the sensors (221) may include acoustic sensors, such as accelerometers, measurement microphones, contact microphones, and hydrophones. Likewise, the sensors (221) may include other types of sensors, such as transmitters and receivers to measure resistivity, gamma ray detectors, etc. The sensors (221) may include hardware and/or software for generating different types of well logs (such as acoustic logs or density logs) that may provide well data about a wellbore, including porosity of wellbore sections, gas saturation, bed boundaries in a geologic formation, fractures in the wellbore or completion cement, and many other pieces of information about a formation. If such well data is acquired during drilling operations (i.e., logging-while-drilling), then the information may be used to make adjustments to drilling operations in real-time. Such adjustments may include rate of penetration (ROP), drilling direction, altering mud weight, and many others drilling parameters.

In some embodiments, acoustic sensors may be installed in a drilling fluid circulation system of a drilling system (200) to record acoustic drilling signals in real-time. Drilling acoustic signals may transmit through the drilling fluid to be recorded by the acoustic sensors located in the drilling fluid circulation system. The recorded drilling acoustic signals may be processed and analyzed to determine well data, such as lithological and petrophysical properties of the rock formation. This well data may be used in various applications, such as steering a drill bit using geosteering, casing shoe positioning, etc.

The control system (244) may be coupled to the sensor assembly (223) in order to perform various program functions for up-down steering and left-right steering of the drill bit (224) through the wellbore (216). More specifically, the control system (244) may include hardware and/or software with functionality for geosteering a drill bit through a formation in a lateral well using sensor signals, such as drilling acoustic signals or resistivity measurements. For example, the formation may be a reservoir region, such as a pay zone, bed rock, or cap rock.

Turning to geosteering, geosteering may be used to position the drill bit (224) or drill string (215) relative to a boundary between different subsurface layers (e.g., overlying, underlying, and lateral layers of a pay zone) during drilling operations. In particular, measuring rock properties during drilling may provide the drilling system (200) with the ability to steer the drill bit (224) in the direction of desired hydrocarbon concentrations. As such, a geosteering system may use various sensors located inside or adjacent to the drill string (215) to determine different rock formations within a well path. In some geosteering systems, drilling tools may use resistivity or acoustic measurements to guide the drill bit (224) during horizontal or lateral drilling.

Turning to FIG. 2B FIG. 2B illustrates some embodiments for steering a drill bit through a lateral pay zone using a geosteering system (290). As shown in FIG. 2B, the geosteering system (290) may include the drilling system (200) from FIG. 2A. In particular, the geosteering system (290) may include functionality for monitoring various sensor signatures (e.g., an acoustic signature from acoustic sensors) that gradually or suddenly change as a well path traverses a cap rock (230), a pay zone (240), and a bed rock (250). Because of the sudden change in lithology between the cap rock (230) and the pay zone (240), for example, a sensor signature of the pay zone (240) may be different from the sensor signature of the cap rock (230). When the drill bit (224) drills out of the pay zone (240) into the cap rock (230), a detected amplitude spectrum of a particular sensor type may change suddenly between the two distinct sensor signatures. In contrast, when drilling from the pay zone (240) downward into the bed rock (250), the detected amplitude spectrum may gradually change.

During the lateral drilling of the wellbore (216), preliminary upper and lower boundaries of a formation layer's thickness may be derived from a geophysical survey and/or an offset well obtained before drilling the wellbore (216). If a vertical section (235) of the well is drilled, the actual upper and lower boundaries of a formation layer (i.e., actual pay zone boundaries (A, A′)) and the pay zone thickness (i.e., A to A′) at the vertical section (235) may be determined. Based on this well data, an operator may steer the drill bit (224) through a lateral section (260) of the wellbore (216) in real time. In particular, a logging tool may monitor a detected sensor signature proximate the drill bit (224), where the detected sensor signature may continuously be compared against prior sensor signatures, e.g., of the cap rock (230), pay zone (240), and bed rock (250), respectively. As such, if the detected sensor signature of drilled rock is the same or similar to the sensor signature of the pay zone (240), the drill bit (224) may still be drilling in the pay zone (240). In this scenario, the drill bit (224) may be operated to continue drilling along its current path and at a predetermined distance (0.5h) from a boundary of a formation layer. If the detected sensor signature is same as or similar to the prior sensor signatures of the cap rock (230) or the bed rock (250), respectively, then the control system (244) may determine that the drill bit (224) is drilling out of the pay zone (240) and into the upper or lower boundary of the pay zone (240). At this point, the vertical position of the drill bit (224) at this lateral position within the wellbore (216) may be determined and the upper and lower boundaries of the pay zone (240) may be updated, (for example, positions B and C in FIG. 2B). In some embodiments, the vertical position at the opposite boundary may be estimated based on the predetermined thickness of the pay zone (240), such as positions B′ and C′.

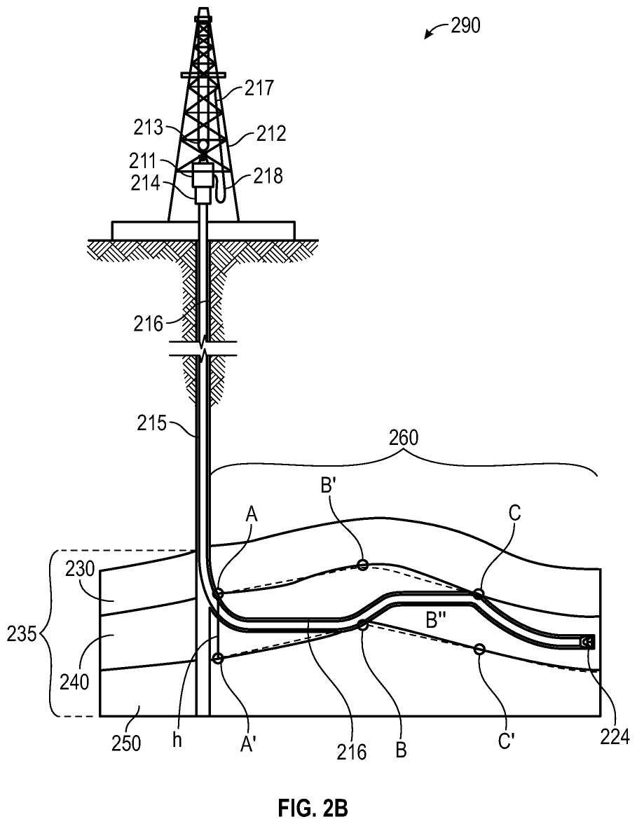

Turning to FIG. 3, FIG. 3 shows a schematic diagram in accordance with one or more embodiments. As shown in FIG. 3, FIG. 3 illustrates a hydraulic stimulation operation that forms additional fractures (312) within a formation (302). More specifically, a wellbore (304) may be located within formation (302), where a casing string (306) is positioned within the wellbore (304). Following a hydraulic fracturing process, for example, large fractures (310) may exist within the formation (302) and extend outward from the wellbore (304). In particular, hydrocarbon reserves may be trapped within certain low permeability formations, such as tight sand, carbonate, and/or shale formations. Thus, stimulation treatments may be performed by a stimulation control system coupled to a well completion assembly or well completion system that enhances well productivity at one or more wells, where one type of stimulation treatment is hydraulic fracturing. In some embodiments, for example, hydraulic fracturing includes injecting high viscosity fluids into a wellbore at a sufficiently high injection rate so that enough pressure is produced within the wellbore to split the formation. As such, a stimulation operation may be determined that achieves a desired height and/or length of one or more induced fractures.

Keeping with FIG. 3, various stimulation procedures may be employed that use one or more techniques to ensure that an induced fracture becomes conductive after injection ceases. For example, during acid fracturing of carbonate formations, acid-based fluids may be injected into the formation to create an etched fracture and conductive channels. These conductive channels may be left open upon closure of the induced fracture. With sand or shale formations, a proppant may be included with the hydraulic fracturing fluid such that the induced fracture remains open during or following a stimulation treatment. Likewise, in carbonate formations, a stimulation treatment may include both acid fracturing fluids and proppants. Accordingly, heat produced within a formation, acid, or aqueous water transmitted into the formation may all play a role in producing reactions causing one or more microfractures in a formation.

Keeping with hydraulic fracturing, a hydraulic fracturing operation may include well completion assembly with one or more inflatable packers as well as a work string or casing string (306) that extends within a wellbore. A casing string may include steel casing or pipe that may be divided into surface casing, intermediate casing, and/or production casing. Packers may include inflatable packers that seal an annulus defined between well completion equipment and an inner wall of the wellbore in order to divide a formation into multiple wellbore intervals. These wellbore intervals may be separately or simultaneously stimulated during a hydraulic stimulation operation using a stimulation control system. Thus, in a hydraulic fracturing operation, a hydraulic fracturing fluid may be pumped using a pump system through the casing string (306) and into a targeted formation using various perforations (i.e., open holes) in the casing string (306).

With respect to pump systems, a pump system may include hardware and software with functionality for supplying hydraulic stimulation fluid to a wellbore at one or more predetermined pressures and/or at one or more predetermined flow rates. For example, a pump system may include one or more displacement pumps that inject the hydraulic stimulation fluid into a wellbore. Likewise, a pump system may include a pump controller that includes hardware and/or software for adjusting local flow rate and pump pressures, e.g., in response to a command from a hydraulic stimulation manager. A pump system may also obtain and/or store sensor data from one or more sensors coupled to a wellbore regarding one or more pump operations. For example, pressure data regarding a hydraulic stimulation operation may be acquired by a pump system from wellhead sensors or downhole sensors disposed in a wellbore. While a pump system may correspond to a single pump, in some embodiments, a pump system may correspond to multiple pumps.

By injecting the hydraulic fracturing fluid at pressures high enough to cause the rock within the targeted formation to fracture, the hydraulic fracturing operation may “break down” the formation. As high-pressure fluid injection continues, a fracture may continue to propagate into a fracture network. This high pressure for injecting the hydraulic fracturing fluid may be referred to as the “propagation pressure” or “extension pressure.” As an induced fracture continues to grow, a proppant, such as sand, may be added to the fracturing fluid. Once a desired fracture network is formed, the fluid flow may be reversed, and the liquid portion of the fracturing fluid is removed. The proppant is intentionally left behind to prevent the fractures from closing onto themselves due to the weight and stresses within the formation. Accordingly, the proppant may “prop” or support the induced fractures to remain open, by remaining sufficiently permeable for hydrocarbon fluids to flow through the induced fracture. Thus, a proppant may form a packed bed of particles with interstitial void space connectivity within a formation. Accordingly, a higher permeability fracture may result from the hydraulic fracturing operation.

In some embodiments, for example, a hydraulic fracturing fluid with an activator is injected into the formation (302), where the fluid migrates within the large fractures (310). Upon a reaction caused by the activator, the injection fluid may produce one or more gases and heat, thereby causing the microfractures (312) to be created within the formation (302). Thus, a stimulation treatment may provide pathways for the hydrocarbon deposits trapped within the formation (202) to migrate and be recovered by a production well. In other words, hydraulic stimulation operations may be applied to formations that easily fracture to produce more microfractures with little plastic deformation under compression.

Furthermore, fracture monitoring may be important to understanding and optimizing hydraulic fracturing treatments. For example, a hydraulic stimulation manager may perform diagnostics that determine various stimulation effects such as fracture geometry, proppant placement in one or more fractures, and/or fracture conductivity. This fracture monitoring may be performed using a distributed acoustic sensing (DAS) system implemented within a wellbore. In some embodiments, a DAS system includes various fiber-optic sensors (e.g., distributed over a single mode optical fiber several kilometers in length). As such, backscattered light may be measured and further analyzed using signal processing techniques to enable a DAS system to segregate an optical fiber into an array of individual acoustic receivers. More specifically, various pulses of light may be transmitted along the optical fiber, where characteristics of the backscattered light may change due to acoustic vibrations disturbing the casing of the optical fiber. Through DAS processing, the location of these disturbances may be identified.

Keeping with DAS systems, pumping operations may produce various acoustic signals along a wellbore and the adjacent fractures, where the acoustic sensing data depends upon geometrical and physical attributes of the propagating fractures. Accordingly, a quantitative DAS inversion may determine various fracture properties in hydraulic fracture monitoring. For example, a wellbore may be profiled in real time by removing DAS pump noise data and matching acquired data to a forward model regarding pulse propagation in the wellbore and adjacent fractures. Thus, DAS inversion may identify various hydraulic stimulation features such as tubing expansion, fluid-to-fluid interfaces, an adjacent hydraulic fracture, presence of a porous reservoir, and/or an annular compartment. During initial phases of a hydraulic stimulation operation, DAS inversion may determine location information of wireline logging equipment within a wellbore. For example, DAS techniques may verify whether perforating guns and packer-setting devices are disposed at desired depths in the wellbore. In some embodiments, DAS inversion is performed using additional data from distributed temperature sensors (DTS) and/or micro-seismic monitoring techniques.

In certain unconventional formations, for example, an important element that determines whether hydrocarbon recovery is economically viable is the presence of one or more sweet spots in the reservoir. A sweet spot may be generally defined herein as the area within a reservoir that represents the best production or potential for production. In a particular geological region, the sweet spot may be determined based on a lack of ductility, a destruction of internal cohesion, an ability for a rock to deform and fail with a low degree of inelastic behavior, and a rock's capability for self-sustaining fracturing. Likewise, sweet spots may include intervals within organic shales, which possess the highest relative hydrocarbon yield for drilling purposes.

Keeping with sweet spots, sweet spot identification may be used by a reservoir simulator to identify one or more drilling location for unconventional wells. In particular, a sweet spot may be determined with certain reservoir characteristics such as reservoir quality and completion quality based on predicted hydrocarbon data, reservoir data, well log data, seismic data, etc. As such, various technologies may be used to extract resources from unconventional reservoirs at certain sweet spots, such as hydraulic fracturing and horizontal wells.

With respect to proppant systems, a well completion system may include a proppant system. A proppant system may include transfer devices, such as chutes and conveyor belts, for transferring a propping agent (also called simply “proppant”) to a fluid mixing system. Likewise, a proppant system may include one or more proppant storage devices, such as a silo, and a housing. In particular, a silo may use fill ports for acquiring propping agents, which may be subsequently transferred to a fluid mixing system using drain valves and/or outlet ports. The proppant system may then dispense the propping agent to the fluid mixing system for producing a stimulation fluid.

Moreover, a stimulation treatment for a formation may be updated by a reservoir simulator using a geological model and/or a hydraulic fracturing model. For example, a reservoir simulator may use a geological model to perform one or more stimulation simulations using different injection fluid pressure rates, different types of proppants, acid-based treatments and non-acid treatments, etc., to determine a desired stimulation scenario for the formation.

Returning to FIG. 1, a reservoir simulator (160) may include hardware and/or software with functionality for generating and/or updating one or more geological models (170) for use in analyzing the formation (106). For example, the reservoir simulator (160) may store well logs and core sample data (150), and further analyze the well log data, the core sample data, seismic data, and/or other types of data to generate and/or update one or more geological models (170).

While FIGS. 1, 2A, 2B, and 3 show various configurations of components, other configurations may be used without departing from the scope of the disclosure. For example, various components in FIGS. 1, 2A, 2B, and 3 may be combined to create a single component. As another example, the functionality performed by a single component may be performed by two or more components.

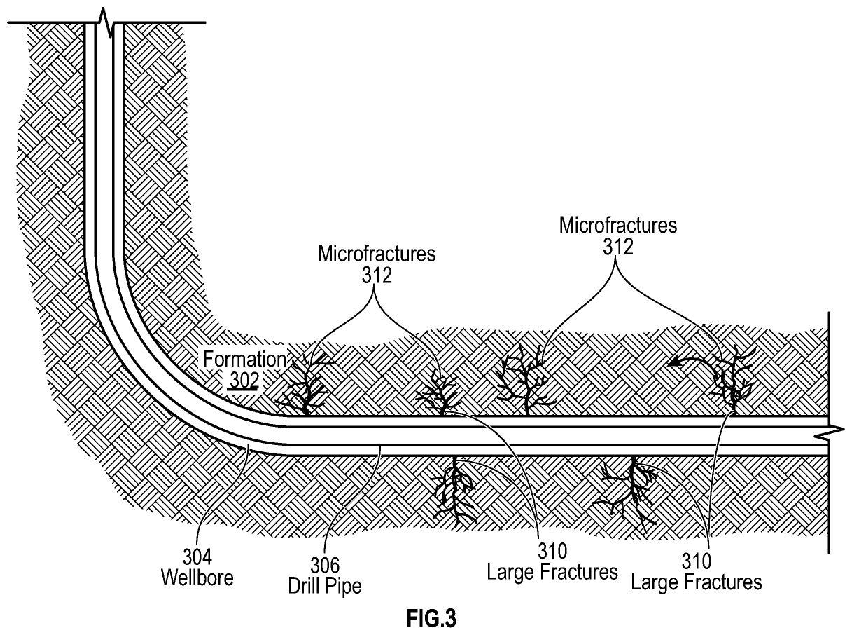

Turning to FIG. 4, FIG. 4 shows a flowchart in accordance with one or more embodiments. Specifically, FIG. 4 describes a general method for determining one or more wellbore breakdown pressures, such for hydraulic stimulation operations. One or more blocks in FIG. 4 may be performed by one or more components (e.g., reservoir simulator (160), control system (114), control system (244)) as described in FIGS. 1, 2A, 2B, and 3. While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 400, reservoir data are obtained for a geological region of interest in accordance with one or more embodiments. Reservoir data may include information regarding various in-situ conditions, such as vertical stress on a wellbore, maximum and minimum horizontal stresses on a wellbore, pore pressure data, and formation temperature data. Likewise, reservoir data may also include permeability data, porosity data, and similar data such as effective porosity data or effective permeability data. Furthermore, a geological region of interest may be a portion of a geological area or volume that includes one or more wells or formations of interest desired or selected for further analysis, e.g., for determining a location of hydrocarbons or reservoir development purposes for a respective reservoir. In some embodiments, the geological region of interest may include a predetermined distance around a wellbore selected for hydraulic stimulation.

In Block 405, geological data regarding one or more formations are obtained for a geological region of interest in accordance with one or more embodiments. Geological data may include various formation properties include density, Young's modulus, Poisson's ratio, thermal conductivity, specific heat, and a thermal expansion coefficient of one or more geological regions.

In some embodiments, geological data may be acquired using well logging tools, coring techniques, cutting samples, and other techniques for acquiring geological data on one or more formations in a reservoir. Likewise, geological data may also include geological property information derived from well logs, core samples, and other data sources. Moreover, the geological data may be obtained in real time from cutting samples (e.g., from cuttings acquired during a drilling operation).

In Block 410, wellbore data are obtained for a wellbore in a geological region of interest in accordance with one or more embodiments. For example, wellbore data may describe static well data, such as wellbore radius, inclination angle, and well azimuths. Likewise, wellbore data may also include dynamic data for various well conditions, such as wellbore pressure data and wellbore temperature data.

In Block 415, elapsed time data is determined between a drilling operation for a wellbore and one or more hydraulic stimulation operations in the geological region of interest in accordance with one or more embodiments. For example, a reservoir simulator may obtain a hydraulic fracturing operation time from a well control system or a user device. In some embodiments, a reservoir simulator may analyze a hydraulic fracturing job plan to determine the lapse of time between a drilling operation for one or more wellbores and the subsequent hydraulic fracturing operations.

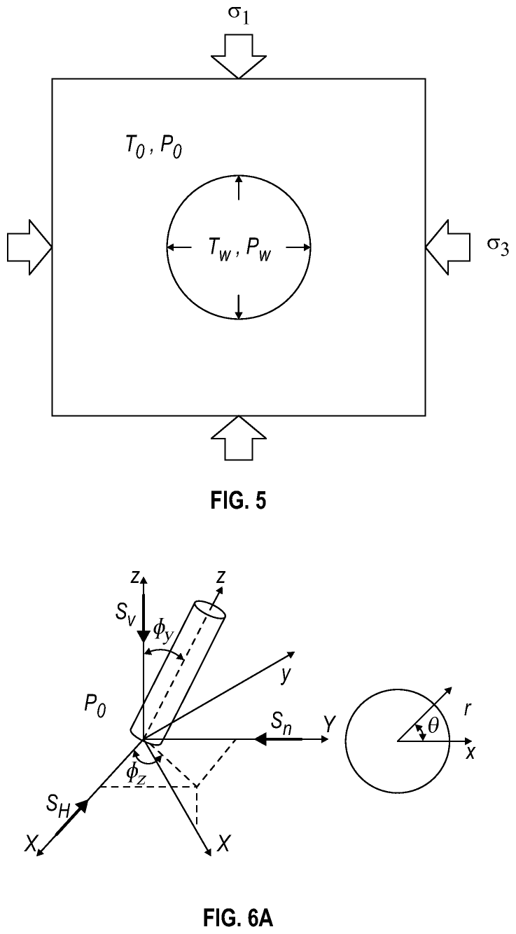

In Block 420, one or more stress components are determined based on reservoir data and/or wellbore data in accordance with one or more embodiments. In some embodiments, for example, various in-situ stresses (S_{V}, S_{H}, Sₕ) are transformed to different stress components (e.g., (Sₓₓ, S_{yy}, S_{zz}, S_{xy}, S_{yz}, S_{zx}) as shown in FIGS. 6A-6B) regarding an inclined and/or horizontal borehole system in a geological region of interest.

Turning to FIGS. 6A and 6B, FIGS. 6A-6B shows a stress transform being applied to an inclined borehole in accordance with one or more embodiments. In FIG. 6A, a borehole system is shown with an inclined borehole that is illustrated being subjected to in-situ stress loading. In FIG. 6B, the inclined borehole with confining stresses is shown transformed from in-situ stresses to borehole coordinates. As such, FIG. 6B shows various equivalent far-field stresses in borehole's local cylindrical coordinate system. In some embodiments, various stress transformations are performed using the following equations:

$$[ \begin{matrix}{S}_{xx} \\ {S}_{yy} \\ {S}_{zz} \\ {S}_{xy} \\ {S}_{xz} \\ {S}_{yz}\end{matrix} ] = [ \begin{matrix}{cos}^{2} {φ}_{Z} {cos}^{2} {φ}_{y} & {sin}^{2} {φ}_{Z} {cos}^{2} {φ}_{y} & {sin}^{2} {φ}_{y} \\ {sin}^{2} {φ}_{Z} & {cos}^{2} {φ}_{Z} & 0 \\ {cos}^{2} {φ}_{Z} {sin}^{2} {φ}_{y} & {sin}^{2} {φ}_{Z} {sin}^{2} {φ}_{y} & {cos}^{2} {φ}_{y} \\ - cos {φ}_{Z} cos {φ}_{y} sin {φ}_{Z} & sin {φ}_{Z} cos {φ}_{y} cos {φ}_{Z} & 0 \\ {cos}^{2} {φ}_{Z} cos {φ}_{y} sin {φ}_{y} & {sin}^{2} {φ}_{Z} cos {φ}_{y} sin {φ}_{y} & sin {φ}_{y} cos {φ}_{y} \\ - cos {φ}_{Z} sin {φ}_{y} sin {φ}_{Z} & sin {φ}_{Z} sin {φ}_{y} cos {φ}_{Z} & 0\end{matrix} ] [ \begin{matrix}{S}_{H} \\ {S}_{h} \\ {S}_{V}\end{matrix} ] \qquad Equation 5$$

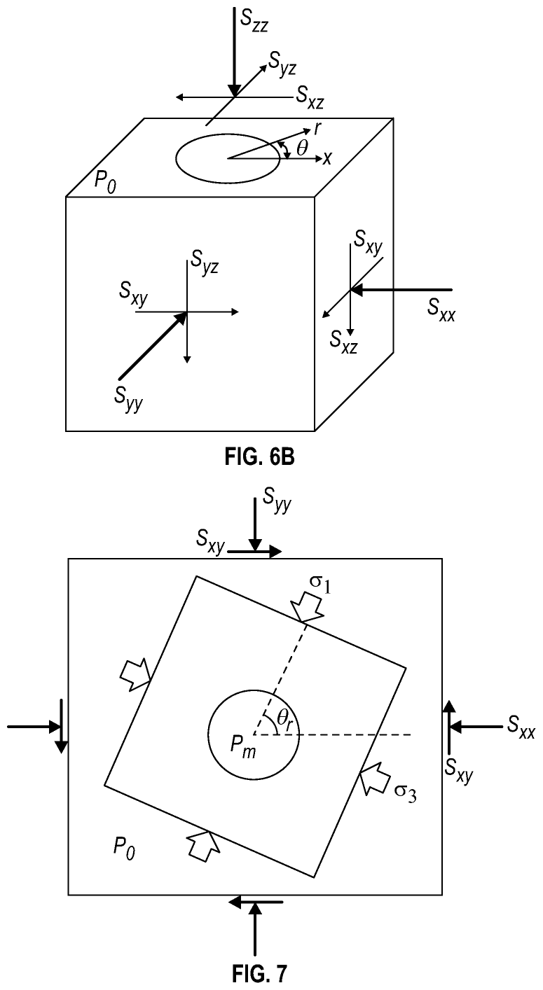

When loaded by a fluid pressure inside a borehole, the borehole may be fractured by converting the tangential stress into tension with magnitudes greater than tensile strength. In a two-dimensional plane strain borehole model, the borehole may be subjected to the loads of Sₓₓ, S_{yy} and S_{xy} in the far-field and mud pressure Pₘ inside the borehole. An equivalent model is a borehole subject to loads of two principal stresses, i.e., σ₁ and σ₂, in the far-field, as demonstrated in a plane strain borehole model in FIG. 7. The σ₁, σ₂ and the angle θᵣ may be computed from Sₓₓ, S_{yy} and S_{xy} using the following equations:

$${σ}_{1} = \frac{{S}_{xx} + {S}_{yy}}{2} + \frac{\sqrt{{( {S}_{xx} - {S}_{yy} )}^{2} + 4 {S}_{xy}^{2}}}{2} \qquad Equation 6$$

$${σ}_{3} = \frac{{S}_{xx} + {S}_{yy}}{2} - \frac{\sqrt{{( {S}_{xx} - {S}_{yy} )}^{2} + 4 {S}_{xy}^{2}}}{2} \qquad Equation 7$$

$${θ}_{r} = \frac{1}{2} {tan}^{- 1} \frac{2 {S}_{xy}}{{S}_{xx} - {S}_{yy}} \qquad Equation 8$$

Returning to FIG. 4, in Block 425, borehole stress data are determined for a wellbore based on reservoir data and/or one or more stress components in accordance with one or more embodiments. In particular, the borehole stress data may correspond confining stresses of a wellbore based on various stress components determined using reservoir data, wellbore data, and/or geological data. For example, stress components may be determined using Equation (5) above, then confining stress data (σ₁, σ₃) may be determined using Equations (6)-(8).

In Block 430, thermal diffusivity data are determined regarding one or more temperature fronts in a geological region of interest based on geological data, time elapse data, and/or reservoir data in accordance with one or more embodiments. For example, thermal diffusivity data may correspond to an amount of thermal diffusion time scale for one or more temperature wavefronts in response to one or more drilling operations at a well site. For illustration, in most sandstone formations, hydraulic diffusivity of fluid flow c_{P} may be in the order of 10⁻³-10⁰ m²/sec, while thermal diffusivity of heat conduction c_{T} may be in the order of 10⁻⁷-10⁻⁶ m²/sec. Because the time scale of thermal diffusion may be very small in relation to the time scale of hydraulic diffusion, a respective formation may be assumed to have a constant pore pressure. In other words, reservoir pressure may dissipate around a wellbore at a significantly faster rate than temperature throughout a geological region. As such, a geological region around a wellbore may be modeled with an original formation pore pressure (p₀) if the wellbore is sealed, or a well fluid pressure (p_{w}) if the wellbore is not sealed.

Furthermore, thermal diffusivity data may describe one or more characteristic times that one or more temperature fronts propagate a predetermined distance from a wellbore (e.g., a characteristic length L). For example, a coefficient of thermal diffusion c_{T} may be determined using Equation 4 above. More specifically, a characteristic length L may be set to a predetermine distance (e.g., 10 times the borehole radius) to determine a characteristic time t_{T} of thermal diffusion in a geological region. In some embodiments, the characteristic time is determined using the following equation:

$${t}_{T} = \frac{{L}^{2}}{{c}_{T}} \qquad Equation 9$$

where L corresponds to a predetermined distance that may be a function of the borehole radius (R_{w}). For example, a stress state at distance L of 10 R_{w} may converge to the stress state in the far field. Where borehole radius R_{w} is typically around 0.1 m, a temperature front may take a day to a week depending on a formation type (e.g., different sandstone formations may have different thermal diffusion rates) for the temperature front to propagate to 1 m away from the well.

Furthermore, if the elapsed time tₒₚ between a drilling operation and a hydraulic completion operation is greater than a characteristic time t_{T}, the temperature field around the wellbore may be treated as being in a thermal steady state distribution. If the elapsed time tₒₚ is smaller than the characteristic time t_{T}, the transient response of one or more temperature fronts may affect the wellbore breakdown pressure of the hydraulic completion operation. For example, the thermal stress increment may change one or more normal stress components. In some embodiments, the change in stress components based on changes in thermal stress is determined using the following equation:

$${Δσ}_{ij} = 2 G {Δε}_{ij} + \frac{2 Gv}{1 - 2 v} {Δε}_{kk} {δ}_{ij} - {η}_{P} Δ p {δ}_{ij} + K {α}_{S} Δ T {δ}_{ij} \qquad Equation 10$$

where Δσᵢⱼ corresponds to an incremental stress tensor, Δεᵢⱼ corresponds to an incremental strain tensor, G is the shear modulus, η_{P} corresponds to an efficiency value, K corresponds to a bulk modulus of a geological region, v is Poisson's ratio of a geological region; α is the Biot's coefficient of effective stress for the geological region, α_{S} is the thermal expansion coefficient for the geological region, Δp is a pore pressure change in the formation where the pore pressure change is zero in an impermeable borehole and (p_{w}−p₀) in a permeable borehole, ΔT corresponds to a temperature change in the formation, and δᵢⱼ is the Kronecker delta function. In some embodiments, the efficiency value η_{P} and the bulk modulus K are determined using the following equations:

$${η}_{P} = α \frac{1 - 2 v}{1 - v} \qquad Equation 11$$

$$K = \frac{2 G ( 1 + v )}{3 ( 1 - 2 v )} \qquad Equation 12$$

In Block 440, one or more wellbore breakdown pressures are determined for one or more hydraulic stimulation fluids based on thermal diffusivity data, time elapse data, borehole stress data, and/or permeability data for a geological region of interest in accordance with one or more embodiments. In particular, wellbore breakdown pressure may describe a hydraulically-induced pressure that is used for fracture initiation in a horizontal or inclined well. As such, wellbore breakdown pressure may be dependent on well inclination and drilling directions because wellbore tensile failures may be different in such cases. Additionally, wellbore breakdown pressure may be a time-dependent value based on an elapsed amount of time since a drilling operation produced the corresponding wellbore.

In some embodiments, for example, an amount of necessary breakdown pressure for a hydraulic fracture is determined by well trajectory, in-situ stress, tensile strength of a stratum, and an initial pore pressure of a geological region. More specifically, wellbore breakdown pressure may be an important hydraulic operation parameter for a particular hydraulic fracturing design and construction process. In some embodiments, wellbore breakdown pressure is determined based on a comparison between elapsed time tₒₚ between a drilling operation and a well completion operation with the characteristic time of thermal diffusion tr. In some embodiments, for example, the comparison is expressed using the following relationship:

$${t}_{op} \geq {t}_{T} \qquad Expression 13$$

In this case of Expression 13, a temperature front has penetrated into a rock mass to the depth of ten times of borehole radius, where the stress concentration induced by borehole drilling essentially disappears. In other word, after this point, additional thermal propagation of a temperature front may not have significant influence on the stress concentration around the wellbore. As such, the temperature distribution around the wellbore may be close to a steady state. For permeable boreholes, wellbore breakdown pressure may be determined using the following equation:

$${P}_{b} = \frac{3 {σ}_{3}^{′} - {σ}_{1}^{′} + {η}_{T} ( {T}_{w} - {T}_{0} ) + {σ}^{T}}{2 - {η}_{P}} + {p}_{0} \qquad Equation 14$$

where of σ′₁=σ₁−p₀, σ′₃=σ₃−p₀, are the maximum and minimum original effective principal stresses or confining stresses, respectively, and the thermal efficiency value η_{T} may be expressed using the following equation:

$${η}_{T} = \frac{( 1 - 2 v )}{( 1 - v )} K {α}_{S} \qquad Equation 15$$

For impermeable boreholes, the wellbore breakdown pressure may be determined using the following equation:

$${P}_{b} = 3 {σ}_{3}^{′} - {σ}_{1}^{′} + {η}_{T} ( {T}_{w} - {T}_{0} ) + {σ}^{T} + {p}_{0} \qquad Equation 16$$

In another case, the elapsed time after a drilling operation and before the hydraulic fracturing completion operation is very small relative to the characteristic thermal diffusion time. As such, fluid may only cool down the stress to a very shallow depth on the wellbore wall. Thus, the stress concentration around the wellbore is essentially not affected that much by the fluid cooling. This case may be expressed using the following expression:

$${t}_{op} < 0.001 * {t}_{T} \qquad Expression 17$$

Therefore, the thermal effect may be ignored, the breakdown pressure can be calculated by elastic solutions. For permeable boreholes, the breakdown pressure may be determined using the following equation:

$${P}_{b} = \frac{3 {σ}_{3}^{′} - {σ}_{1}^{′} + {σ}^{T}}{2 - {η}_{P}} + {p}_{0} \qquad Equation 18$$

For impermeable boreholes, the wellbore breakdown pressure may be determined using the following equation:

$${P}_{b} = 3 {σ}_{3}^{′} - {σ}_{1}^{′} + {σ}^{T} + {p}_{0} \qquad Equation 19$$

In another case, a minimum effective tangential stress around the wellbore, σ′_{θθ-min}, evolves with time, where a wellbore breakdown pressure's value at time tₒₚ can be determined using a reservoir simulator that implements semi-analytical thermomechanical or numerical solutions of wellbore stresses. In some embodiments, this case is illustrated using the following expression:

$$0.001 * {t}_{T} \leq {t}_{op} < {t}_{T} \qquad Expression 20$$

In Block 450, one or more stimulation operations are determined for a geological region of interest based on one or more wellbore breakdown pressure in accordance with one or more embodiments. For example, a stimulation operation may be based on a chosen well path as described above in FIGS. 1, 2A, 2B, and 3, and the accompanying description. Based on a planned elapsed time between a drilling operation and a hydraulic stimulation operation, for example, stimulation parameters may be determined based on a predicted wellbore breakdown pressure as well as other stimulation inputs, such as fracturing fluid, injection rate, injection consequence, etc. for a hydraulic fracturing operation or other stimulation operation. For example, a stimulation operation may be determined and/or implemented as described above in FIG. 3 and the accompanying description.

In Block 460, one or more commands are transmitted to one or more control systems based on one or more stimulation operations in accordance with one or more embodiments. For example, commands may be transmitted to various control systems to automate drilling operations or stimulation operations as necessary for drilling or completing a well. Likewise, a user may select different stimulation parameters or adjusted drilling parameters based on predicted hydrocarbon data. A user selection may be obtained within a graphical user interface.

In Block 470, one or more stimulation operations are performed based on one or more commands in accordance with one or more embodiments.

For an illustrative example, a reservoir simulator may collect data regarding in-situ conditions, formation properties, and well conditions. In particular, in-situ conditions may include an overburden stress (S_{V}) gradient=1.05 psi/ft, a maximum horizontal stress (S_{H}) gradient=0.85 psi/ft, a minimum horizontal stress (Sₕ) gradient=0.80 psi/ft, a pore pressure (p₀) gradient=0.48 psi/ft, a formation temperature (T₀)=100° C., and an azimuth of maximum horizontal stress=0°. The reservoir simulator may further collect rock properties for a geological region of interest that includes a Young's modulus (E)=1.2 Mpsi, a Poisson's ratio (v)=0.3, a cohesion (c)=1360 psi, a friction angle (φ)=30°, a tensile strength (σ^{T})=0, a bulk density (φ=2000 kg/m³, a volumetric thermal expansion coefficient (α_{S})=5×10⁻⁵ l/° C., a bulk thermal conductivity (k_{T})=2.65 w/m·° C., and a bulk specific heat (C_{V})=200 cal/kg·° C. Moreover, the reservoir simulator may obtain wellbore trajectory and geometry data that includes a true vertical depth (TVD) of 5000 ft, a borehole radius=4 in, an inclination=90°, an azimuth=90°, a drilling mud pressure (p_{w})=10 ppg=0.52 psi/ft, a drilling mud temperature (T_{w})=50° C., and information that the borehole is permeable. The reservoir simulator further determines a hydraulic fracturing operation time tₒₚ of two weeks. After collecting data, the reservoir simulator may determine principal confining stresses where S_{V}=5250 psi, S_{H}=4250 psi, Sₕ=4000 psi, p₀=2400 psi. Using Equations (5)-(8), the reservoir simulator may determine σ₁=5250 psi and σ₃=4250 psi.

Next, the reservoir simulator determines a thermal diffusivity and a character time as expressed in the below equations:

$${c}_{T} = \frac{{k}_{T}}{ρ {C}_{V}} = 1.59 \times {10}^{- 6} \frac{{m}^{2}}{sec} \qquad Equation 19$$

$$L = 10 {R}_{w} = 1 m \qquad Equation 20$$

$${t}_{T} = \frac{{L}^{2}}{{c}_{T}} = 176 hours \qquad Equation 21$$

Furthermore, the reservoir simulator determines a characteristic time of thermal diffusion to be about a week. Since the hydraulic fracturing operation is performed at two weeks after drilling, i.e., tₒₚ≥t_{T}, the wellbore breakdown pressure is determined using the following equation:

$${P}_{b} = \frac{3 {σ}_{3}^{′} - {σ}_{1}^{′} + {η}_{T} ( {T}_{w} - {T}_{0} ) + {σ}^{T}}{2 - {η}_{P}} + {p}_{0} = 3.29 ksi \qquad Equation 22$$

Embodiments may be implemented on a computer system. FIG. 8 is a block diagram of a computer system (802) used to provide computational functionalities associated with described algorithms, methods, functions, processes, flows, and procedures as described in the instant disclosure, according to an implementation. The illustrated computer (802) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (802) may include a computer that includes an input device, such as a keypad, keyboard, touch screen, or other device that can accept user information, and an output device that conveys information associated with the operation of the computer (802), including digital data, visual, or audio information (or a combination of information), or a GUI.

The computer (802) can serve in a role as a client, network component, a server, a database or other persistency, or any other component (or a combination of roles) of a computer system for performing the subject matter described in the instant disclosure. The illustrated computer (802) is communicably coupled with a network (830) or cloud. In some implementations, one or more components of the computer (802) may be configured to operate within environments, including cloud-computing-based, local, global, or other environment (or a combination of environments).

At a high level, the computer (802) is an electronic computing device operable to receive, transmit, process, store, or manage data and information associated with the described subject matter. According to some implementations, the computer (802) may also include or be communicably coupled with an application server, e-mail server, web server, caching server, streaming data server, business intelligence (BI) server, or other server (or a combination of servers).

The computer (802) can receive requests over network (830) or cloud from a client application (for example, executing on another computer (802)) and responding to the received requests by processing the said requests in an appropriate software application. In addition, requests may also be sent to the computer (802) from internal users (for example, from a command console or by other appropriate access method), external or third-parties, other automated applications, as well as any other appropriate entities, individuals, systems, or computers.

Each of the components of the computer (802) can communicate using a system bus (803). In some implementations, any or all of the components of the computer (802), both hardware or software (or a combination of hardware and software), may interface with each other or the interface (804) (or a combination of both) over the system bus (803) using an application programming interface (API) (812) or a service layer (813) (or a combination of the API (812) and service layer (813). The API (812) may include specifications for routines, data structures, and object classes. The API (812) may be either computer-language independent or dependent and refer to a complete interface, a single function, or even a set of APIs. The service layer (813) provides software services to the computer (802) or other components (whether or not illustrated) that are communicably coupled to the computer (802). The functionality of the computer (802) may be accessible for all service consumers using this service layer. Software services, such as those provided by the service layer (813), provide reusable, defined business functionalities through a defined interface. For example, the interface may be software written in JAVA, C++, or other suitable language providing data in extensible markup language (XML) format or other suitable format. While illustrated as an integrated component of the computer (802), alternative implementations may illustrate the API (812) or the service layer (813) as stand-alone components in relation to other components of the computer (802) or other components (whether or not illustrated) that are communicably coupled to the computer (802). Moreover, any or all parts of the API (812) or the service layer (813) may be implemented as child or sub-modules of another software module, enterprise application, or hardware module without departing from the scope of this disclosure.

The computer (802) includes an interface (804). Although illustrated as a single interface (804) in FIG. 8, two or more interfaces (804) may be used according to particular needs, desires, or particular implementations of the computer (802). The interface (804) is used by the computer (802) for communicating with other systems in a distributed environment that are connected to the network (830). Generally, the interface (804 includes logic encoded in software or hardware (or a combination of software and hardware) and operable to communicate with the network (830) or cloud. More specifically, the interface (804) may include software supporting one or more communication protocols associated with communications such that the network (830) or interface's hardware is operable to communicate physical signals within and outside of the illustrated computer (802).

The computer (802) includes at least one computer processor (805). Although illustrated as a single computer processor (805) in FIG. 8, two or more processors may be used according to particular needs, desires, or particular implementations of the computer (802). Generally, the computer processor (805) executes instructions and manipulates data to perform the operations of the computer (802) and any algorithms, methods, functions, processes, flows, and procedures as described in the instant disclosure.

The computer (802) also includes a memory (806) that holds data for the computer (802) or other components (or a combination of both) that can be connected to the network (830). For example, memory (806) can be a database storing data consistent with this disclosure. Although illustrated as a single memory (806) in FIG. 8, two or more memories may be used according to particular needs, desires, or particular implementations of the computer (802) and the described functionality. While memory (806) is illustrated as an integral component of the computer (802), in alternative implementations, memory (806) can be external to the computer (802).

The application (807) is an algorithmic software engine providing functionality according to particular needs, desires, or particular implementations of the computer (802), particularly with respect to functionality described in this disclosure. For example, application (807) can serve as one or more components, modules, applications, etc. Further, although illustrated as a single application (807), the application (807) may be implemented as multiple applications (807) on the computer (802). In addition, although illustrated as integral to the computer (802), in alternative implementations, the application (807) can be external to the computer (802).

There may be any number of computers (802) associated with, or external to, a computer system containing computer (802), each computer (802) communicating over network (830). Further, the term “client,” “user,” and other appropriate terminology may be used interchangeably as appropriate without departing from the scope of this disclosure. Moreover, this disclosure contemplates that many users may use one computer (802), or that one user may use multiple computers (802).

In some embodiments, the computer (802) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, a cloud computing system may operate according to one or more service models, such as infrastructure as a service (IaaS), platform as a service (PaaS), software as a service (SaaS), mobile “backend” as a service (MBaaS), artificial intelligence as a service (AIaaS), serverless computing, and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining reservoir data for a first geological region of interest;
obtaining geological data regarding one or more formations in the first geological region of interest;
performing, by a first drilling system comprising a drill bit and a drill string, a first drilling operation to produce a first wellbore in the first geological region of interest;
determining, by a computer processor, first time elapse data describing an amount of time between the first drilling operation and a first hydraulic stimulation operation;
determining, by the computer processor, borehole stress data based on the first wellbore, the reservoir data, and the geological data;
determining, by the computer processor, thermal diffusivity data regarding one or more temperature fronts in the first geological region of interest based on the first time elapse data, the reservoir data, and the geological data;
determining, by the computer processor, a first wellbore breakdown pressure of the first geological region of interest based on the thermal diffusivity data, the geological data, the borehole stress data, and the reservoir data; and
transmitting, by the computer processor, a first command to a stimulation control system based on the first wellbore breakdown pressure,
wherein the stimulation control system performs a hydraulic stimulation operation at the first wellbore based on the first wellbore breakdown pressure and in response to the first command.

2. The method of claim 1, further comprising:
determining a change in pressure in the first geological region of interest based on the one or more temperature fronts diffusing throughout the first geological region of interest based on the amount of time between the first drilling operation and the first hydraulic stimulation operation, and
wherein the first wellbore breakdown pressure is based on the change in pressure.

3. The method of claim 1, further comprising:
obtaining wellbore data regarding the first wellbore, wherein the wellbore data comprises a wellbore radius of the first wellbore, inclination angle data of the first wellbore, and an azimuth of the first wellbore;
determining a vertical stress on the first wellbore, a maximum horizontal stress on the first wellbore, and a minimum horizontal stress on the first wellbore using the wellbore data and the reservoir data;
determining a plurality of stress components of the first wellbore based on the inclination angle data, a plurality of borehole coordinates, the vertical stress, the maximum horizontal stress, and the minimum horizontal stress; and
determining confining stress data for the first wellbore based on the plurality of stress components,
wherein the borehole stress data comprises the confining stress data.

4. The method of claim 3,
wherein the wellbore data comprises vertical stress data on the first wellbore, minimum horizontal stress data on the first wellbore, and maximum horizontal stress data on the first wellbore.

5. The method of claim 1,
wherein the reservoir data comprises reservoir pore pressure data and reservoir temperature data.

6. The method of claim 1,
wherein the geological data comprises formation density data, Young's modulus data, Poisson's ratio data, thermal conductivity data, specific heat data, and thermal expansion coefficient data.

7. The method of claim 1, further comprising:
obtaining second time elapse data for a second drilling operation and a second hydraulic stimulation operation;
determining whether a second geological region of interest is disposed in a thermal steady state based on the second time elapse data,
wherein the second geological region of interest surrounds a second wellbore that is drilled by the second drilling operation; and
determining, in response to determining that the second geological region of interest being in the thermal steady state, a second wellbore breakdown pressure,
wherein the second wellbore breakdown pressure is time independent.

8. The method of claim 1, further comprising:
obtaining permeability data regarding the first geological region of interest; and
determining whether the permeability data satisfies a predetermined permeability threshold,
wherein the first wellbore breakdown pressure is based on the permeability data satisfying the predetermined permeability threshold.

9. The method of claim 1, further comprising:
performing a second drilling operation at a second wellbore in the first geological region of interest, wherein the second drilling operation acquires a plurality of cuttings from drilling fluid circulated in the second wellbore during the second drilling operation; and
determining cutting data from the plurality of cuttings,
wherein a portion of the geological data is based on the cutting data.

10. The method of claim 1, further comprising:
acquiring, using a coring system comprising a coring tool, one or more core samples from a second wellbore in the first geological region of interest; and
determining core sample data using the one or more core samples,
wherein a portion of the geological data is based on the core sample data.

11. The method of claim 1, further comprising:
acquiring temperature data for the first geological region of interest using a plurality of downhole temperature sensors disposed in the first wellbore;
acquiring pressure data for the first geological region of interest using a plurality of downhole pressure sensors disposed in the first wellbore,
wherein the reservoir data comprises the temperature data and the pressure data.

12. The method of claim 1,
wherein the hydraulic stimulation operation sends a hydraulic fracturing fluid into the first wellbore at a predetermined flow rate using a pump system,
wherein the hydraulic fracturing fluid comprises at least one propping agent, and
wherein the hydraulic fracturing fluid produces a fracture network laterally from the first wellbore.

13. A system, comprising:
a drilling system comprising a drill bit and a drill string;
a stimulation control system; and
a reservoir simulator coupled to the stimulation control system, the reservoir simulator comprising a computer processor,
wherein the drilling system is configured to perform a first drilling operation to produce a wellbore in a geological region of interest, and
wherein the reservoir simulator is configured to perform a method comprising:
obtaining reservoir data for the geological region of interest,
obtaining geological data regarding one or more formations in the geological region of interest,
determining time elapse data describing an amount of time between the first drilling operation and a first hydraulic stimulation operation,
determining borehole stress data based on the wellbore, the reservoir data, and the geological data,
determining thermal diffusivity data regarding one or more temperature fronts in the geological region of interest based on the time elapse data, the reservoir data, and the geological data, and
determining a first wellbore breakdown pressure of the geological region of interest based on the thermal diffusivity data, the geological data, the borehole stress data, and the reservoir data,
wherein the stimulation control system performs a hydraulic stimulation operation at the wellbore based on the first wellbore breakdown pressure.

14. The system of claim 13, further comprising:
a user device coupled to the stimulation control system,
wherein the user device is configured to provide a graphical user interface for presenting a plurality of wellbore breakdown pressures, and
wherein the first wellbore breakdown pressure is selected among the plurality of wellbore breakdown pressures.

15. The system of claim 13, wherein the method further comprises:
determining a change in pressure in the geological region of interest based on the one or more temperature fronts diffusing throughout the geological region of interest based on the amount of time between the first drilling operation and the first hydraulic stimulation operation, and
wherein the first wellbore breakdown pressure is based on the change in pressure.

16. The system of claim 13, wherein the method further comprises:
obtaining wellbore data regarding the wellbore, wherein the wellbore data comprises a wellbore radius of the wellbore, inclination angle data of the wellbore, and an azimuth of the wellbore;
determining a vertical stress on the wellbore, a maximum horizontal stress on the wellbore, and a minimum horizontal stress on the wellbore using the wellbore data and the reservoir data;
determining a plurality of stress components of the wellbore based on the inclination angle data, a plurality of borehole coordinates, the vertical stress, the maximum horizontal stress, and the minimum horizontal stress; and
determining confining stress data for the wellbore based on the plurality of stress components,
wherein the borehole stress data comprises the confining stress data.

17. The system of claim 13,
wherein the geological data comprises formation density data, Young's modulus data, Poisson's ratio data, thermal conductivity data, specific heat data, and thermal expansion coefficient data.

18. The system of claim 13, wherein the method further comprises:
obtaining permeability data regarding the geological region of interest; and
determining whether the permeability data satisfies a predetermined permeability threshold,
wherein the first wellbore breakdown pressure is based on the permeability data satisfying the predetermined permeability threshold.

19. The system of claim 13, wherein the method further comprises:
acquiring temperature data for the geological region of interest using a plurality of downhole temperature sensors disposed in the wellbore;
acquiring pressure data for the geological region of interest using a plurality of downhole pressure sensors disposed in the wellbore,
wherein the reservoir data comprises the temperature data and the pressure data.

20. The system of claim 13,
wherein the hydraulic stimulation operation sends a hydraulic fracturing fluid into the wellbore at a predetermined flow rate using a pump system,
wherein the hydraulic fracturing fluid comprises at least one propping agent, and
wherein the hydraulic fracturing fluid produces a fracture network laterally from the wellbore.
